(19) United States
(12) Patent Application Publication
(10) Pub. No.: US 2008/0314488 A1
(43) Pub. Date: Dec. 25, 2008

(54) Snap-In Valve With a Device for Measurement of Tire Pressure

(75) Inventor: Rainer Achterholt, Landschlacht (CH)

Correspondence Address: FROST BROWN TODD, LLC, 2200 PNC CENTER, 201 E. FIFTH STREET, CINCINNATI, OH, 45202, US

(73) Assignee: Global Dynamix AG, St. Moritz (CH)

(21) Appl. No.: 11/997,367

(22) PCT Filed: Jun. 7, 2006
(86) PCT No.: PCT/EP06/05426

§ 371 Date: Jul. 2, 2008

(30) Foreign Application Priority Data
Aug. 4, 2005 (DE) 19 2005 036 837.9

(51) Int. Cl. B60C 29/02

(52) U.S. Cl. 152/428; 152/427; 152/415

(57) ABSTRACT

The invention concerns a snap-in valve for a vehicle tire with a device (5) for measurement of the tire pressure, in which the device (5) is arranged on a valve foot (15) of the snap-in valve, and the snap-in valve includes a groove (13), into which an edge of a valve hole of the vehicle tire (2) can be snapped, in which an outer cylindrical support device (3) can be connected to the snap-in valve above groove (13) of the snap-in valve, so that an edge surface of the support device at least partially lies against the outer surface of the vehicle tire rim (2).

### AREA OF THE INVENTION

The present invention pertains, in general to valves for vehicles, for example, a land vehicle, like a passenger car, two-, four- or multi-wheeled vehicles, aircraft, etc., especially a snap-in valve with a device mounted on it or integrated in it for measurement of tire pressure of a vehicle tire, and the design of such a device.

### BACKGROUND OF THE INVENTION

Different pressure monitoring systems are generally known for monitoring tire pressure in vehicle tires. In so-called indirect systems, a pressure sensor with a corresponding device for radio transmission of data representing the pressure is ordinarily situated in a module housing fastened within the vehicle tire to a valve. Such a system is known, for example, from EP 0 417 712 B1 (Achterholt). In addition to the valves proposed there, which are firmly connected to the tire rim, flexibly connected or so-called snap-in valves have since become known, as well. These valves, which are encased on the valve foot with a flexible material, for example, rubber, are characterized by simple installation, being merely pulled through a corresponding valve hole of the vehicle tire rim. The edge of the valve hole then snaps into a groove of the elastic valve body, consisting of rubber, for example. The snap-in valve is consequently mechanically held in the hole merely by the elastic rubber element of the valve.

The module housing of this type of indirect measurement system, in which the pressure sensor and a transmitter unit with a battery for power supply is situated, is generally firmly connected to the valve. Such module housings, in the modules now available on the market, have a total weight of about 25 g and more and are therefore much heavier than the part of the valve situated outside the vehicle tire or vehicle [tire] rim. During rotation of the tire, centrifugal forces of different intensity therefore develop on the valve tip and valve foot, to which the module housing is fastened. These different centrifugal forces result in a force that can lead to tilting or turning of the valve and therefore a pressure loss in the vehicle tire.

It is known from document DE 196 13 936 A1 (Continental) to stabilize a snap-in valve by mounting its corresponding counterweight to the module housing on the outside of the valve stem. It is also disclosed to support the valve by means of a corresponding support plate arranged between the valve stem and rim.

DE 43 03 583 C2 (Alpha-Beta Electronics) discloses a valve with a device for measurement and generation of a wireless transmitted pressure display signal for vehicle tires. The device also has an electronic memory that serves to store a reference pressure that is supposed to prevail in a vehicle tire.

Further developments of snap-in valves are generally described in US 2004/0084124 A1.

The task of the present invention is to improve the stability of snap-in valves with a device mounted on them or integrated in them for measuring the tire pressure of the vehicle tire, but, at the same time, permit simple and rapid installation for different types of tire rims.

Another task of the present invention is improve the design of devices for measuring tire pressure of a vehicle tire for snap-in valves, so that replacement of components or parts is possible simply and quickly.

### BRIEF SUMMARY OF THE INVENTION

According to a first aspect, the present invention provides a snap-in valve for a vehicle tire with a device for measurement of tire pressure, in which the device is arranged on a valve foot of the snap-in valve and the snap-in valve encloses a groove, into which one edge of the valve hole of the vehicle tire rim can be snapped. An outer cylindrical support device can be connected to the snap-in valve above the groove of the snap-in valve, i.e., in the mounted state in the area outside the vehicle tire or vehicle [tire] rim, so that an edge surface of the support device lies against the outer surface of the vehicle tire rim, at least partially.

Another aspect of the invention concern the use of the device for measurement of a tire pressure for a snap-in valve of the aforementioned type, in which the device can be connected to the valve foot of the snap-in valve.

Another aspect of the invention concerns a device for measurement of tire pressure of a vehicle tire that can be mounted on the valve foot of a snap-in valve, the device being designed to be firmly or releasably connected to the snap-in valve. The housing of the device, according to this aspect, is designed in two or more parts, specifically with a first housing section facing the valve foot of the snap-in valve, which can be connected to the valve foot of the snap-in valve, and a second housing section that contains an air pressure sensor and is releasably fastened to the first housing section.

Additional aspects and features of the invention are apparent from the dependent claims, the following description of practical examples and the accompanying drawings.

### BRIEF DESCRIPTION OF THE DRAWING

Variants of the invention are now described as examples with reference to the appended drawings, in which:

FIG. 1 shows a schematic sectional view of a snap-in valve according to a first practical example of the present invention;

FIG. 2 explains the forces that act on a snap-in valve mounted in a rim during rotation of the rim;

FIG. 3 shows a schematic sectional view of a snap-in valve according to a second practical example of the present invention;

FIG. 4 shows a schematic sectional view of a snap-in valve according to a third practical example of the present invention;

FIG. 5 shows a schematic sectional view of a snap-in valve according to a fourth practical example of the present invention;

FIG. 6 shows a schematic sectional view of a snap-in valve according to a fifth practical example of the present invention;

FIG. 7 shows a schematic sectional view of a practical example of a snap-in valve and a device for measurement of tire pressure according to an additional aspect of the present invention; and

FIG. 8 shows a schematic sectional view of another practical example of the device for measurement of a tire pressure according to the additional aspect of the present invention.

### DESCRIPTION OF PREFERRED PRACTICAL EXAMPLES

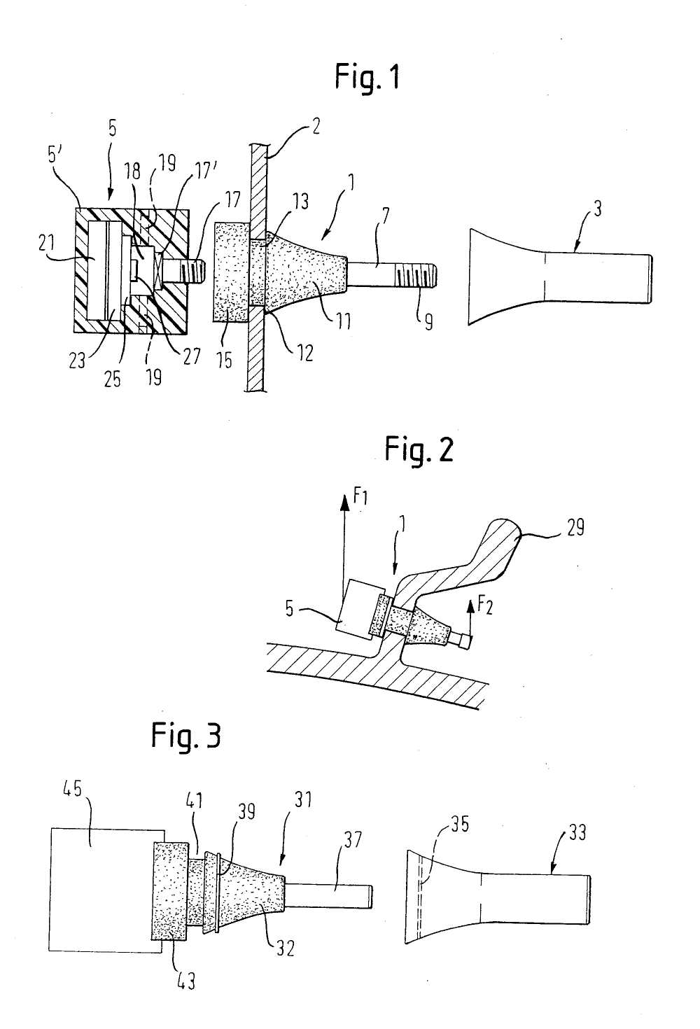

FIG. 1 shows, in detail, a snap-in valve according to a first practical example in a cross-sectional view through the valve. Before detailed description of FIG. 1, general explanations concerning the practical examples follow initially.

Vehicle tires for motor vehicles, like passenger cars, trucks, buses and aircraft, are generally pneumatic tires produced with a tube or tubeless. For long lifetime and optimal physical properties of pneumatic tires, like road holding in the variety of driving situations, like braking, startup, curve travel, etc., it is essential to operate pneumatic tires with the correspondingly prescribed pressure. Among other things, valves with integrated air pressure control systems extending into the interior of the tire are known for pressure monitoring of tires, which continuously measure the tire pressure and transmit a corresponding signal, for example, by radio, to a control unit situated in the vehicle.

Valves for pneumatic tires exist in a variety of variants. A recent development is so-called “snap-in valves”, which are not screwed to the rim, but merely pulled through a valve hole from the inside of the rim and enter into a snap-in connection with the valve hole. In one practice example, a snap-in valve encloses a rubber element, which has a groove in the lower part of the valve, i.e., the side facing the tire, on the valve foot. During installation into the valve hole of the rim, the edge of the valve hole snaps into the groove. In another practical example, such a snap-in valve has a metal internal element, which can consist of brass or aluminum. The metal internal element imparts higher stability to the valve and guarantees tightness even at higher pressures (for example, 7 bar), as, for example, in transports, all-terrain vehicles, house trailers, etc. The tightness at the interface between the valve and rim is achieved by the elastic sealing surface of the rubber element, which encloses the metal inner element. This is elastic, so that after pulling the valve through the rim from the inside out, the valve sits tightly and firmly in a valve hole of the rim.

In one practical example, the tire pressure is recorded with a modular device for measurement of tire pressure, which is releasably arranged on the valve foot of the snap-in valve. This includes, for example, a microchip with integrated pressure sensor. The microchip is mounted in a corresponding circuit on a circuit board and the circuit board is installed in a separate housing within the vehicle tire on the valve. In this housing, a corresponding electronics with antenna to transmit the signal representing the pressure and a battery with high lifetime can additionally be contained. Such housings exist in different forms and are normally connected to the valve (for example, snap-in valve). Since the housing with the elements for pressure measurement and transmission has a certain size and weight, a certain stability of the valve, on which the housing is mounted, is required. In some practical examples of the present invention, a device for measurement of air pressure is built-up in layers. For example, the lowermost layer is a flat battery. A circuit board, which has a pressure sensor and electronics for processing and transmission of data that represent pressure, is situated above it. Preferably, these data are transmitted in wireless fashion. These components can be combined in many practice examples to a compact air pressure measurement module or control module, which weighs only 10 g

In some practical examples, a particular design of snap-in valve with the air pressure measurement module is achieved, in that the air guide of the valve passes through the air pressure measurement module via a hollow bolt. The housing of the air pressure measurement module in these practical examples includes an air guide, which runs through an air collection space in the area of the pressure sensor to the air outlets in the housing of the air pressure measurement module, which communicates with the interior of the tire. Because of this, the air pressure measurement module can be designed compact and mounted simply on a snap-in valve. The snap-in valve can have inside thread in its valve stem. The air pressure measurement module has a hollow bolt with outside thread, which matches the inside thread of the valve stem of the snap-in valve. It is therefore possible to screw the air pressure measurement module onto the snap-in valve.

In other practical examples, the connection between the air pressure measurement module and snap-in valve is achieved by riveting. It is also possible to apply thread to the valve foot of the rubber element or make a bulge on the rubber element of the valve foot. This bulge can then snap into a corresponding groove in a correspondingly shaped housing part of the air pressure measurement module.

Owing to the fact that the weight between the area of the valve situated outside the vehicle tire and the area situated within it is strongly different, during rotation of the tire, different centrifugal forces occur that can lead to tilting or rotation of the valve. This tilting can occur, in particular, in snap-in valves, since they are not tightly screwed to the rim, but are held essentially by the rubber element. The rubber element has a groove in the lower part of the snap-in valve. This groove is limited on the lower side by a larger protrusion of the rubber element, which amounts to a few millimeters. On the upper side of the groove, there is only a small bulge in such valves with a protrusion of about 1 mm, which can be compressed during installation of a snap-in valve, so that the snap-in valve can be pulled through the valve hole. In particular, at high speeds (for example, 270 km/h), tilting of the valve can occur and lead to possible pressure losses or even total loss of tire pressure.

In some practical examples of the present invention, tilting of the valve is prevented by a corresponding outer support device. This outer support device is arranged, for example, on a valve stem of the snap-in valve. A support device in some practical examples is a valve cap, which has inside thread. The valve stem of the snap-in valve has outside thread, onto which the valve cap can be screwed. The valve cap is lengthened relative to ordinary valve caps, so that it reaches the rim and can touch its outside surface. If the valve cap is screwed to the valve stem, a corresponding support force that can prevent tilting of the snap-in valve develops, because of the contact force of the valve cap on a rim surface.

In another practical example, the support device is stabilized in the form of a lengthened valve cap by a support ring. This support ring is situated on the bottom end of the valve stem right in front of the rim. A corresponding groove in the valve cap ensures that the support ring snaps into the groove during installation of the valve cap. The support ring permits an additional stabilization effect, since, because of the elasticity of the rubber element, on which the valve cap lies, a certain motion latitude of the snap-in valve still exists without the support ring.

In another practical example, the outer support element consists of a sleeve-like element. A support ring is mounted on the lower end of the valve stem in this practical example. The sleeve-like support element is shaped, so that it lies properly against the rubber element of the snap-in valve. On the lower edge of the support element, there is a groove, into which the support ring can snap. In addition, the support element and a valve cap can be laid out, so that not only the valve cap, but also the support element can be firmly screwed. In this practical example, only the valve cap, but not the support element therefore need be removed to fill the vehicle tire with air.

In another practical example, an inner support element is also situated on the snap-in valve. As described above, in the installed state, a device for pressure measurement and for transmission of pressure-specific data is situated in the vehicle tire rim on the snap-in valve. This device is preferably fastened to the valve foot of the snap-in valve, for example, screwed to the valve with a hollow bolt. The device is designed cylindrical and protrudes beyond the edge of the valve foot. In this practical example, an inner support element, for example, a shim, is arranged between the device and the inside surface of the vehicle surface. This can be achieved in that the diameter of the hole of the shim is somewhat greater than the diameter of the valve foot and the thickness of the shim corresponds to the intermediate space that forms between the inner surface of the vehicle [tire] rim and the beginning of the aforementioned device. In a modified practical example, the housing of the device for pressure measurement and transmission is configured, so that an edge of the housing that extends beyond the valve foot reaches the inside surface of the rim and can assume a support function.

In other practical examples, a combination of outer and inner support elements, as described above, is implemented. For example, a lengthened valve cap can be implemented as an outer support element and a shim as inner support element—or a correspondingly shaped housing of the device for pressure measurement. Any outer support element can be combined with any inner support element. Practical examples also exist with only one support element—only an outer or only an inner support element.

According to another aspect of the present invention, which can be considered in combination, but also independently of the other aspects, a device for measurement of the tire pressure of a vehicle tire includes a housing that is designed module-like from at least two housing sections or parts. According to one practical example, an air pressure control system for wireless transmission of a signal representing the pressure is accommodated in a housing section, which includes the components required for this, for example, a battery for power supply, processor to process the air pressure data, which are furnished by an air pressure sensor that is preferably situated on a circuit board, together with the process. According to one practical example, another housing section is designed as an intermediate piece or connection device, which connects the housing section that includes the air pressure control system to a valve foot of a snap-in valve. The other housing section contains an air guide system, which is designed communicating with the snap-in valve via air guide channels, both with the tire interior and a corresponding connection, for example, air channels.

According to one practical example, a first and second housing section can be screwed to each other via thread running on the interfaces, for example, the first housing section can be screwed to the valve foot of the snap-in valve. As an alternative, the first housing section is riveted to the valve foot of the snap-in valve via a connection device.

According to one practical example, an air pressure control system arranged in a cavity of the second housing section is provided. In addition, the air pressure control system can include a battery for power supply and a circuit board arranged one above the other, on which a microprocessor to control the air pressure control system and the air pressure sensor, as well as the transmitting unit for wireless transmission of air pressure measurement signals, are arranged.

According to one practical example, the air pressure control system is accommodated in a correspondingly shaped cavity of the second housing section in removable fashion. The battery can also be accommodated in a correspondingly shaped cavity of the second housing section on the bottom of the circuit board. Both permit simple and rapid removal of these components from the housing, if it must be replaced or maintained.

According to another practical example, the components of the air pressure control system are arranged in a sandwich design one above the other in the housing.

Returning to the detailed description of FIG. 1: this shows a snap-in valve 1 of a first practical example of the present invention. The snap-in valve 1 has a valve stem 7 made of metal (for example, brass or aluminum). On one upper end of the valve stem 7, i.e., the end situated outside of the vehicle tire, a thread 9 is provided, onto which a valve cap 3 can be screwed. The snap-in valve also includes a rubber element 11, which has a groove 13 and, on its end, forms the valve 15 on the inside of a vehicle tire 2. The groove 13, in the mounted state of the valve 1, takes up one edge of a valve hole of a vehicle tire rim 13. Because of the fact that the rubber element 11 is elastically deformable, the edge 12, during mounting of the snap-in valve 7, can be compressed, so that the snap-in valve can be pulled through a valve hole. After installation is completed, the elastic rubber element 11 is decompressed again an therefore ensures firm and tight seating of the snap-in valve 1 in the valve hole. The snap-in valve is mounted by pulling it from the inside out through the valve hole of the vehicle tire rim 2. A hole, through which air can flow through the valve, is situated in valve foot 15. In addition, in this practical example, the valve stem 7 also extends into the valve foot (in other practical examples (not shown), the valve stem can also be shorter). A thread is situated in valve stem 7 in the area of the valve foot 15, onto which a module-like device (subsequently also called “air pressure measurement module) can be releasably coupled to measure the tire pressure via a hollow threaded screw 17.

The device 5 is screwed into the valve foot 15 of snap-in valve 1 with hollow bolt 17. The hollow bolt 17 is formed with a head area 17′ secured from rotation on the side facing away from valve foot 15, for example, a square head, which is accommodated in a recess correspondingly formed on the inside wall of the housing. In this way, the device 5 is connected free of rotation with hollow bolt 7. Mounting of the device 5 on a snap-in valve 1 is readily possible without a special tool.

The device 5 includes a symmetric, for example, cylindrical, plastic housing 5′. The symmetric design of the housing of device 5 together with the aforementioned screw connection permits simple assembly even with an already preassembled snap-in valve 1, in which the device 5 can be screwed onto the snap-in valve 1 by full revolution by hand. In this way, the device 5 forms an air pressure measurement module, which, on the one hand, can be applied without complication and quickly onto a snap-in valve 1 and mounted on the vehicle tire rim, but, on the other hand, can also be subsequently “retrofitted” on a snap-in valve already mounted on the vehicle [tire] rim.

A battery 21 that supplies a microprocessor 25 with a pressure sensor 27 with current is situated in the interior of housing 5′. The microprocessor 25 is mounted on a circuit board 23, on which electronics are also present for (for example, wireless) transmission of data. The pressure sensor 27 is situated in an air collecting space 18, which communicates with the snap-in valve 1 through the hollow bolt 1, on the one hand, and with the interior of the vehicle tire rim, on the other hand, through distribution holes 19 running through the housing wall. It is possible, because of this, to fill the tire with air through the snap-in valve 1 and device 5 or allow air to escape, but, at the same time, tire air pressure is also present on the pressure sensor 27. The distribution holes 19 can be present in different numbers is device 5; good filling of the vehicle tire is guaranteed, for example, with six distribution holes 19, each with a diameter of 2 mm.

FIG. 2 shows a snap-in valve 1, for example, in the form just described, incorporated in a vehicle tire rim 29. During rotation of the rim, the forces F₁ and F₂ act on the snap-in valve 1. Since the left part of the snap-in valve 1 with device 5 is heavier than the right part of snap-in valve 1, the centrifugal force F₁ is greater than the centrifugal force F₂. At high speed, for example, at more than 230 km/h, the force difference of the two centrifugal forces F₁ and F₂ leads to tilting of rotation of the valve in the direction of force F₁.

Rotation and tilting of the snap-in valve is prevented in a first practical example by the valve cap 3, as shown in FIG. 1. The valve cap 3 has an internal thread, which cooperates with thread 9 on the valve stem 7 of snap-in valve 1. The valve cap 3 is also designed, in terms of shape, so that it fits over the rubber element 11 of snap-in 1 and extends to the surface of rim 2. By correspond screwing of valve cap 3, which preferably consists of a metal, like aluminum or brass, among others, the snap-in valve 1 is therefore supported by the fastened valve cap 3, which at least partially lies on the outside of rim 2. The rubber element 11 of the snap-in valve can also be reinforced by the adjacent body of the valve cap. In addition, the edge of valve cap 3 lies so firmly on the surface of rim, that tilting of the snap-in valve 1 is reduced or prevented up to high speeds, for example, 270 km/h, so that the tightness of the snap-in valve us guaranteed.

FIG. 3 shows a second practical example. The snap-in valve 31 has a valve stem 37, which is provided in this practical example without thread. The rubber element 32 has a groove 41 and a valve foot 43. A module-like device 45 to measure the tire pressure sits on valve 43, which corresponds essentially to device 5 from the first practical example. In addition, the rubber element 32 has a support ring 39, which is preferably made of metal (for example, stainless steel, iron, copper, aluminum, etc.) or another stable material, like plastic. The valve cap 33 has a groove 35, designed so that the support ring 39 can snap into this groove. Naturally, thread can also be formed on valve stem 37, in addition to the support ring 39 and the valve cap 33 can have a corresponding thread. The support ring 35 reinforces the rubber element 32 and therefore increases the overall support effect of valve cap 33, so that tilting of the snap-in valve at high speed is also prevented in this practical example, or at least reduced to the extent that tightness is guaranteed nevertheless.

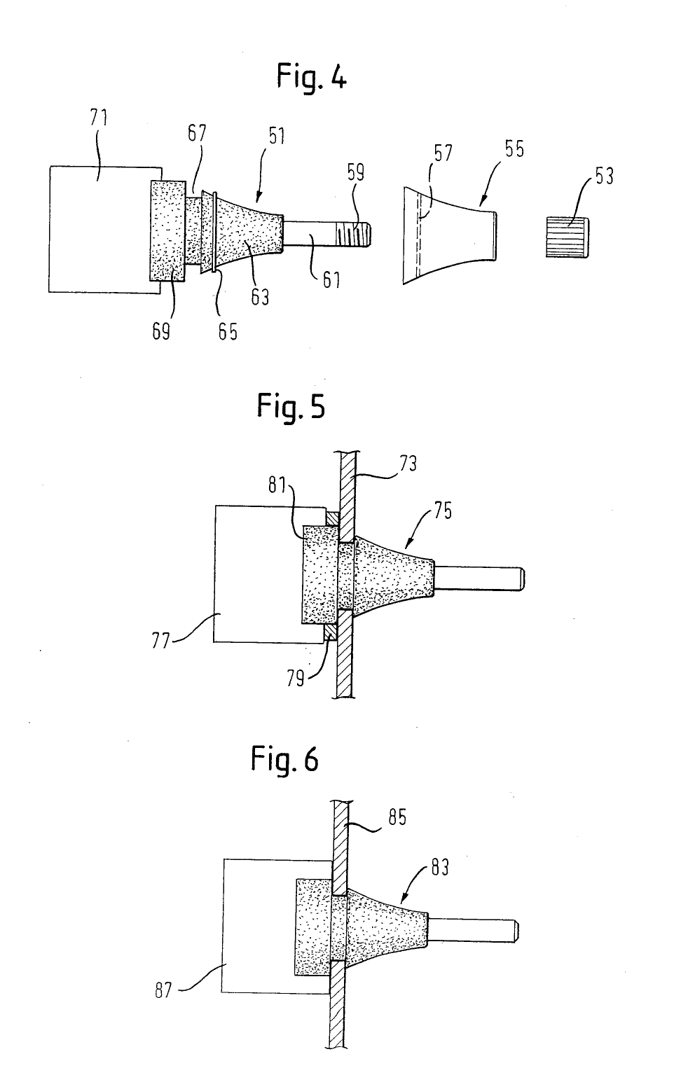

A third practical example is shown in FIG. 4. Snap-in valve 51 consists of a valve stem 61 with thread 59, rubber element 63, which has a groove 67 and a valve foot 69. A support ring 65 is also situated on rubber element 63. A support element 55 with a groove 57 corresponding to support ring 65 can also be positioned on the support ring 65. The support element is designed conical-cylindrical, so that it can be positioned to fit on rubber element 63. An individual valve cap 53 can be screwed onto thread 59. In this practical example, the vehicle tire can be filled without removing the support element 55.

In a practical example not shown, in addition to support ring 65, a thread is made on the valve stem 61. In this practical example, the support ring 65 can also be omitted. The support element 55 of this practical example has an additional inside thread that can be screwed onto the additional thread on the valve stem 61. For this purpose, it is necessary that the diameter of this additional thread be greater than that of the thread 59 for valve cap 53, so that the support element 55 can be pushed over thread 59 and only engage on the additional thread.

Another practical example is shown in FIG. 5. Here an internal support element in the form of a disk 79 is arranged between a rim 73 and a device 77 for pressure measurement and transmission of pressure-relevant data. This disk 79 can be made from metal or plastic or any other material having sufficient hardness that withstands the corresponding forces. The disk 79 has an inside hole with a diameter that corresponds at least to the diameter of valve foot 81.

The practical example in FIG. 6 shows a snap-in valve 83, as was described further above. This snap-in valve 83 is situated in a valve hole of rim 85. The housing of the device 87 is designed here, so that it lies at least partially against the inside surface of rim 85. Because of this, the additional inner support device, which was shown in the practical example of FIG. 5, can be omitted.

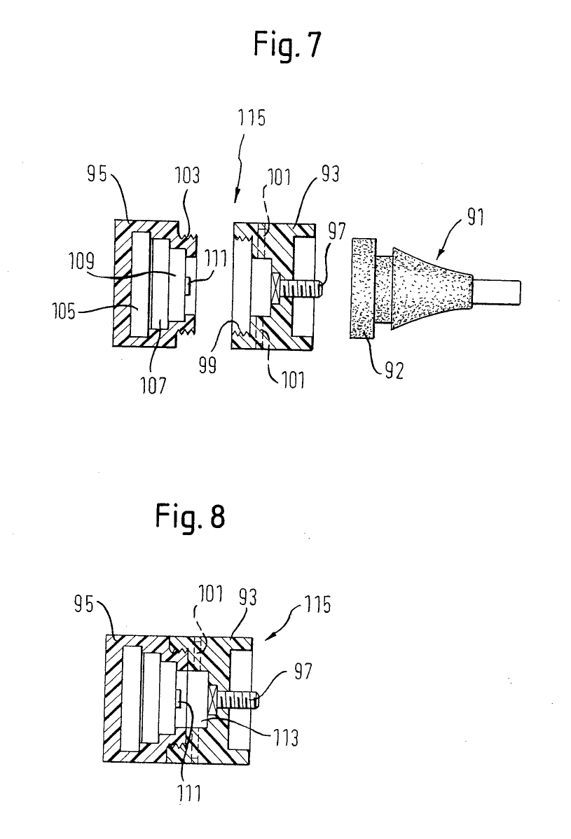

A practical example of another aspect of the present invention, but which can be considered in combination or independently from the other aspects, concerns a snap-in valve 91 with a device 115 for measurement of the tire pressure of a vehicle tire according to FIGS. 7 and 8.

FIG. 7 shows a two-part design of device 115 with two housing sections 93 and 95 separated from each other, whereas FIG. 8 shows the two housing sections 93 and 95 connected to each other. The first housing section 93 faces a valve foot 92 of snap-in valve 91, whereas the second housing section 95 is connected to the side of the housing section 93 facing away from snap-in 91. The housing section 93, on its side facing the valve foot, has a hollow bolt 97 with a thread that cooperates with thread in a valve stem in valve foot 92 of the snap-in valve 91. The hollow bolt 97 has a shaft and edge head section, which is situated on the end of the hollow bolt 97 facing away from the valve foot. This edge head section prevents rotation of the hollow bolt 97 during fastening of housing section 93 on the valve foot. The hollow bolt 97 is situated in the middle of a cylindrical cavity of the housing section 93, whose diameter corresponds at least to that of the valve foot. By screwing the thread of the hollow bolt 97 with the thread in the valve foot of the snap-in valve 91, the housing section 93 can enter into a releasable connection with snap-in valve 91. If the housing section 93 is screwed onto the valve foot, the cavity, in which the hollow bolt 97 is situated, takes up the valve foot. In other (not shown) practical examples, the connection between the valve foot and the housing section 93 is produced by another connection device, for example, a rivet connection between the valve foot and a connection device on the housing section 93. Housing section 93 also includes air guide channels 101, which belong to an air guide system formed between the tire interior of a vehicle tire and communicating with the snap-in valve 91 via the hollow bolt 97. A cylindrical cavity on the side of the housing section 93 facing away from the valve foot also belongs to this air guide system. The cylindrical cavity has a smaller inside diameter than a second cylindrical cavity, also situated on this side of the housing section, and has inside thread 99 on this inside wall. This thread 99 is designed to match an outside thread 103 situated on the outside of a cylindrical housing part of housing section 95. By means of these two matching threads 99 and 103, a releasable, but simultaneously stable connection can be made between the housing sections 93 and 95.

This releasable connection can be implemented in a different way according to practical examples (not shown). For example, in many practical examples, the two housing sections 93 and 95 are screwed to each other by at least two screws. A thread corresponding to one screw is provided in housing section 93, whereas in the other housing section 95, a mount, which is situated in an indentation of the housing section 95 corresponding to the screw head, is provided for the screws. In other practical examples a connection between the two housing sections 93 and 95 is produced by a plug connection. In this case, for example, at least two opposite tabs are molded onto the outside of housing section 93, whereas corresponding elastic mounts are molded on the outside of the other housing section 95, into which the tabs can snap when the two housing sections 93 and 95 are brought together.

The housing section 95 contains an air pressure control system, which has a circuit board 107 with a microprocessor 109 and an air pressure sensor 111 and a battery 105 for power supply. In addition, the air pressure control system, in many practical examples, has a transmission unit for wireless transmission of a signal that indicates the air pressure of the vehicle tire, for example, or contains a corresponding signal that the air pressure does not correspond to a stipulated reference value. Both the components (circuit board 107, microprocessor 103, air pressure sensor 111, etc.) of the air pressure control system and the battery 105 are situated in a correspondingly shaped cavity of the housing section 95. In many practical examples, the components of the air pressure control system and the battery 105 are accommodated loosely, i.e., removably, in this cavity of the housing section 95, so that at least the battery 105, or also other parts of the air pressure control system can be replaced as required, for example, when the battery 105 is dead or the air pressure sensor 111 has a defect. In some practical examples, the individual components of the air pressure control system are arranged one above the other in a sandwich design. For example, in the direction from the bottom up of snap-in valve 91, viewed toward the housing section 95, first battery 105, then circuit board 107, on which the microprocessor 109 is situated (and, for example, also the transmission unit), and the air pressure sensor 111 on its top, are arranged.

FIG. 8 shows the two housing sections 95 and 93 in a connected state. The shaping of the two housing sections 95 and 93 is such, that in the connected state, they form a cavity 103 that lies above the pressure sensor 111. The cavity 113 is formed here, for example, by the cylindrical cavity of housing section 93 and a cylindrical cavity corresponding in diameter, positioned above the air pressure sensor 111 of housing section 95. This cavity 111 is part of the air guide system and is connected to communicate via air guide channels 101 with the tire interior of the vehicle tire and via hollow bolt 97 with the snap-in valve 91. If air is filled via snap-in valve 91 into the tire interior of the vehicle tire, this first flows through the interior of the valve shape of snap-in valve 91, then goes through hollow bolt 97, which is screwed into the valve stem, into cavity 113 and is distributed from there into the tire interior through the air guide channels 101. The air guide channels 101 have a diameter of about 2 mm, for example, and lead from cavity 113 outward from housing section 93. Viewed from the hollow bolt 97 in the direction of cavity 111, the air guide channels 101, in some practical examples, are arranged concentric and from the inside out. A number of, for example, 6, such air guide channels 101 is sufficient, in order to fill the vehicle tires with air. After filling of the vehicle tire, the tire air pressure lies on the air pressure sensor 111 based on the communicating connection of cavity 113 to the tire interior via the air guide channels 101.

Because of the two-part design of the device 115 described above and the releasable connection between housing section 93 and housing section 95, it is possible to simply replace housing section 95 even in the mounted state of device 115 on snap-in valve 91. For example, during a defect in battery 105, the housing section 95 can be unscrewed and replaced by another correspond housing section with a new battery. Replacement of battery 105 in the practical examples in which the circuit board 107 with microprocessor 109 and the air pressure sensor 111 situated on it and the battery 105 are accommodated removable by hand or with a special tool in the cavity of housing section 95 is particularly simple. Here only the components just mentioned need be loosened and the battery can be replaced. The components of the air pressure control system and the housing section 95 can therefore be used again. In many practical examples, because of the aforementioned layered structure of the air pressure control system and the releasable installation of the air pressure control system and its individual components in housing section 95, replacement of individual components is possible.

1. Snap-in valve for a vehicle tire with a device (5) for measurement of the tire pressure, in which the device (5) is arranged on a valve foot (15) of the snap-in valve, and the snap-in valve includes a groove (13), into which one edge of a valve hole of a vehicle tire rim (2) can be snapped,
characterized by the fact that
an outer cylindrical support device (3; 33; 55) can be connected above groove (15) of snap-in valve to the snap-in valve, so that an edge surface of the support device (3; 33; 55) lies at least partially against the outer surface of the vehicle tire rim (2).

2. Snap-in valve according to claim 1, in which an internal support device (79; 87) is connected beneath groove (13) to the snap-in valve, so that it lies against the inside surface of the vehicle tire rim (2).

3. Snap-in valve according to claim 1, in which the outer support device (3; 33; 55) includes a valve cap.

4. Snap-in valve according to claim 3, in which the valve cap can be screwed onto the snap-in valve.

5. Snap-in valve according to claim 3, in which the snap-in valve includes a support ring (35) and the valve cap is designed, so it can be mounted on the support ring.

6. Snap-in valve according to claim 2, in which the internal support device is a metal disk arranged between device (5) and the inner surface of the vehicle surface.

7. Snap-in valve according to claim 1, in which the device (5) for measurement of the tire pressure is releasably connected as a module to the valve foot (15) of the snap-in valve.

8. Snap-in valve according to claim 1, in which the device (5) for measurement of tire pressure includes a layered structure of its housing section.

9. Snap-in valve according to claim 7, in which the releasable connection is produced via a hollow bolt (17), which is positioned in the device (5) for measurement of the tire pressure.

10. Snap-in valve according to claim 9, in which the hollow bolt (17), on its side facing away from valve foot (15), has a head area (17′) mounted secured against rotation in the housing of device (5).

11. Snap-in valve according to claim 9, in which the snap-in valve has inside thread in valve foot (15).

12. Snap-in valve according to claim 1, in which the device (5) includes a pressure sensor, which is arranged in the interior of device (5) in the area of an air chamber, which, on the one hand, communicates via one or more holes (19) with the tire interior and, on the other hand, with the snap-in valve via a hollow bolt (17).

13. Snap-in valve according to claim 1, in which the device (5) for measurement of the tire pressure has a symmetric housing.

14. (canceled)

15. Device for measurement of tire pressure of a vehicle tire, which can be mounted on the valve foot (92) or snap-in valve (91), in which:
the device (115) is designed firmly or releasably connectable to snap-in valve (91), and
the housing device (115) is designed in two or more parts, with a first housing section (93) facing the valve foot (92) of the snap-in valve, which can be connected to the valve foot (92) of the snap-in valve (91), and a second housing section (95), which contains an air pressure sensor (111) and is releasably fastened to the first housing section (93).

16. Device (115) according to claim 15, in which the first and second housing sections (93, 95) can be screwed to each other via a thread (99, 103) running on the interfaces.

17. Device (115) according to claim 15, in which the first housing section (93) can be screwed onto the valve foot (92) of the snap-in valve.

18. Device (115) according to claim 15, in which the first housing section (93) is riveted via a connection device to the valve foot (92) of snap-in valve (91).

19. Device (115) according to one claim 15, which includes an air pressure control system (105, 107, 109) arranged in a cavity of the second housing section (95).

20. Device (115) according to claim 19, in which the air pressure control system includes a battery (105) for a power supply and a circuit board (107) arranged one above the other, on which a microprocessor (109) to control the air pressure control system, the air pressure sensor (111) and a transmitting unit for wireless transmission of air pressure measured signals are arranged.

21. Device (115) according to claim 19, in which the air pressure control system is accommodated removable on a correspondingly shaped cavity of the second housing section (95).

22. Device (115) according to claim 19, in which the battery (105) is accommodated removable in a correspondingly shaped cavity of the second housing section (95) on the bottom of circuit board (107).

23. Device (115) according to claim 19, in which the components (105, 107, 109, 111) of the air pressure control system are arranged in a sandwich design one above the other.
